(19) United States
(12) Patent Application Publication
(10) Pub. No.: US 2002/0083787 A1
(43) Pub. Date: Jul. 4, 2002

(54) Hypoid gears a drive-on-coast application

(75) Inventor: Gulliver J. Silvagi, Shelby Township, MI (US)

Correspondence Address: BRINKS HOFER GILSON & LIONE, P.O. BOX 10395, CHICAGO, IL, 60610, US

(73) Assignee: Visteon Global Technologies, Inc.

(21) Appl. No.: 09/750,408

(22) Filed: Dec. 28, 2000

(51) Int. Cl. F16H 55/06; F16H 55/08; F16H 55/10

(52) U.S. Cl. 74/466

(57) ABSTRACT

A hypoid gear set including a ring-shaped gear positioned about an axis and having a plurality of curved gear teeth arranged about the axis. Each tooth has a second side having a forward face with a shallow pressure angle relative to an axially extending line and defining the drive side of the gear. Each tooth has a first side having a rear face with a steep pressure angle relative to an axially extending line and defining the coast side. A pinion gear drives the rear faces of the ring-shaped gear such that the ring-shaped gear rotates in the direction of the forward faces of the teeth of the ring-shaped gear.

### FIELD OF THE INVENTION

This invention relates generally to the field of gears for use in automobile differentials. In particular, this invention relates to a new design for a hypoid gear set mounted in a drive-on-coast side application for use in a power-take-off or rear axle of an automobile.

### DESCRIPTION OF THE RELATED ART

It is common practice to use hypoid gear sets in automobile differentials. A hypoid gear set consists of a ring-shaped gear meshed with a pinion gear. The ring gear typically has a set of generally axially upstanding curved teeth arranged on a flat surface of a ring-shaped portion. The curved shape of the teeth results from their spiral arrangement, which cuts down on gear noise and increases the gear power. The pinion gear may contact the ring gear at a point either above or below the axis of the ring gear. The teeth of the pinion gear necessarily share the same pressure angles as the teeth of the ring gear. The pinion gear teeth are also curved in a spiral arrangement. This type of gear arrangement allows the gear set to change the direction of the power flow. In most cases, the direction of power flow is turned 90 degrees. For this reason, hypoid gear sets are used in the drive train of automobiles to transfer power to the wheels from the transmission drive shaft. Another benefit of hypoid gear sets is that they have high speed and strength capabilities.

It is well known in the prior art that the sides of the gear teeth that are predominantly used in the driving direction should be cut with a steeper pressure angle than the coast, or reverse side. The steeper pressure angle provides increased strength and efficiency in the direction of rotation. If the drive side were not cut with this steeper pressure angle, there would be more noise from the gear and less power. It is not plausible to have a steep pressure angle on both sides of the teeth. This would result in a nearly square-shaped gear tooth, creating a weaker pinion and a noisier gear set.

Recently, in some power-take-off applications, it has become necessary to mount some hypoid gear sets in a reversed direction. These are known as drive-on-coast side applications. This reverse mounting requirement results from the packaging constraints of these applications. In a power train system, there are two sets of these gears. The second set transfers some power to the rear wheels while the first set supplies power to the front wheels. This implements a four-wheel drive mechanism for the automobile. However, because of the small size of the power-take-off box and the numerous support rods along with other parts, there is insufficient space in which to mount the hypoid gears in the correct orientation.

In many new power-take-off applications, the only way to fit the hypoid gear set in the package is to mount it such that the pinion is reversed from its normal position. By mounting the pinion in this position, the normal drive side of the hypoid gear set becomes the coast side, and vice versa. Therefore, to run the automobile in the forward direction, the drive force from the pinion is applied to the teeth with the shallow pressure angle. This results in a loss of efficiency and fatigue strength of the hypoid gear.

In the past, the standard method to avoid this loss of efficiency and strength has been to mount the pinion such that it intersects the ring gear at a point above the ring gear axis instead of at a point below the axis. However, in new power-take-off applications, the supports obstruct the space around the gears. In order to keep the small size of the power-take-off box, the pinion must intersect the ring gear below the axis and must be run backwards.

### BRIEF SUMMARY OF THE INVENTION

In one embodiment of the present invention, a hypoid gear set includes a ring-shaped gear positioned about an axis and having a plurality of curved gear teeth arranged about the axis. Each tooth has a second side having a forward face with a shallow pressure angle relative to an axially extending line and defining the drive side of the gear. Each tooth has a first side having a rear face with a steep pressure angle relative to an axially extending line and defining the coast side. The embodiment also includes a pinion gear meshing with the ring-shaped gear. The pinion gear drives the rear faces of the ring-shaped gear such that the ring-shaped gear rotates in the direction of the forward faces of the teeth of the ring-shaped gear.

The invention may also be embodied in a method of cutting a new hypoid ring gear based on a standard hypoid ring gear, the standard hypoid ring gear having a plurality of teeth each with a first side defining the coast side and having a first pressure angle, and second side defining the drive side and having a second pressure angle. The method includes the steps of determining the first and second pressure angles of the standard hypoid ring gear and then determining the inverse angles of the first and second pressure angles. Then, the inverse first pressure angle is cut into the drive side of the new hypoid ring gear and the inverse second pressure angle is cut into the coast side of the new hypoid ring gear.

In another embodiment of the invention, a ring-shaped hypoid gear includes a base with a plurality of curved teeth each having a convex side facing in the direction of rotation of the ring-shaped hypoid gear. Each of the teeth also has a drive side on the concave face of each tooth that receives a driving force from a pinion gear and a coast side on a convex face opposite the concave face.

The present embodiments provide a number of important advantages over the prior art. By locating the steep pressure angle on the coast side of the ring-shaped gear teeth, the hypoid gear set can provide more efficient power and greater fatigue strength when run in the reverse direction than can a standard hypoid gear set. This hypoid gear set can be mounted in a machine that requires that the gear set be run in the coast direction to drive the machine in a forward direction. Running this hypoid gear set in this manner does not result in a loss of power or fatigue strength, as did running a prior art hypoid gear set in the reverse direction.

It is to be understood that both the preceding summary and the following detailed description are intended to be exemplary and are intended to provide a further explanation of the invention claimed. The invention will best be understood by reference to the following detailed description read in conjunction with the accompanying drawings.

### BRIEF DESCRIPTION OF SEVERAL VIEWS OF THE DRAWINGS

FIG. 1 shows a prior art hypoid gear set consisting of a ring-shaped gear and a pinion;

FIG. 2 is an enlarged perspective view of a prior art ring-shaped gear tooth;

FIG. 3 is an enlarged perspective view of a ring-shaped gear tooth of the present invention;

FIG. 4 is a perspective view of the ring-shaped gear and the pinion gear of present invention;

FIG. 5 is an enlarged perspective view of the present invention along line 1-1 in FIG. 4, showing the interaction of the teeth of the ring-shaped gear and the pinion gear; and

FIG. 6 shows an example of a hypoid gear set mounted within a rear axle carrier.

### DETAILED DESCRIPTION OF THE INVENTION

Referring to the Figures, FIG. 1 shows a standard hypoid gear set known in the prior art. A pinion gear 10 intermeshes with a ring-shaped gear 12 at a point below the axis 14 of the ring-shaped gear 12. The ring-shaped gear 12 has a first side 16 and a second side 18. The first side 16 is flat and the second side 18 has a plurality of teeth 20 extending axially from the second side 18, each of which has a drive side 22 and a coast side 24. The drive side 22 is the side to which pressure is applied on the ring-shaped gear 12 by the pinion 10 in order to move the machine in a forward direction. The direction of rotation is called the drive direction as shown by the arrow 26.

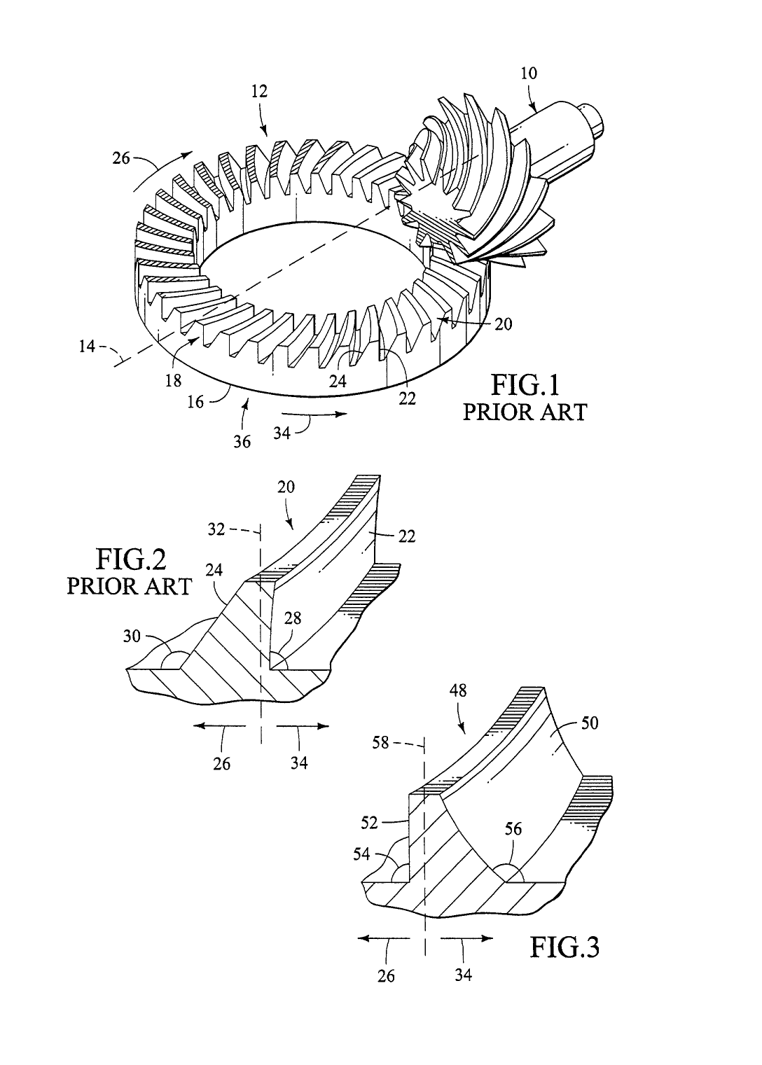

FIG. 2 shows an enlarged view of one of the teeth 20 of a prior art ring-shaped gear 12. Each tooth 20 has a first pressure angle 28 and a second pressure angle 30. The first pressure angle 28 is on the drive side 22 and the second pressure angle 30 is on the coast side 24. Again, the direction of rotation is shown in the Figure by the arrow 26. In the prior art, the first pressure angle 28 is much steeper than the second pressure angle 30 in reference to an axially extending line 32. This provides maximum power from the pinion 10 to the ring-shaped gear 12 and creates a more efficient hypoid gear set. It is not plausible to cut both the first pressure angle 28 and the second pressure angle 30 in a steep manner. Doing so would result in a nearly square-shaped tooth, which results in more noise, friction, heat and gear wear. Plus, the pinion gear 10 necessarily must match the teeth of the ring-shaped gear 12, and a pinion gear 10 with square-shaped teeth is much weaker than a pinion gear 10 with angled teeth. However, the drawback to cutting a steep pressure angle in one side of the teeth 20 of the ring-shaped gear 12 is that the second pressure angle 30 must remain shallow. In certain situations, namely in new machines that utilize four-wheel-drive, it is necessary to run the hypoid gear set in a reversed, or coast direction 34 in order to get the machine to run forward. This results from the fact that it is impossible to mount the pinion 10 either above the axis 14 of the ring-shaped gear 12 or mount the pinion 10 such that it intersects the ring-shaped gear 12 from the opposite side 36. The designer must therefore mount the pinion 10 in the manner shown in FIG. 1, and then run it in a coast direction 34 in order to drive the machine in a forward direction 26. Since this method uses the coast side 24 of the teeth 20 to drive the machine, it is called a “drive-on-coast” mechanism. Unfortunately, due to the shallow second pressure angle 30, the hypoid gear set loses much of its power when driven in the coast direction 34. This leads to decreased efficiency and a loss of fatigue strength, causing the hypoid gear set to wear more rapidly than if it were run in the proper direction.

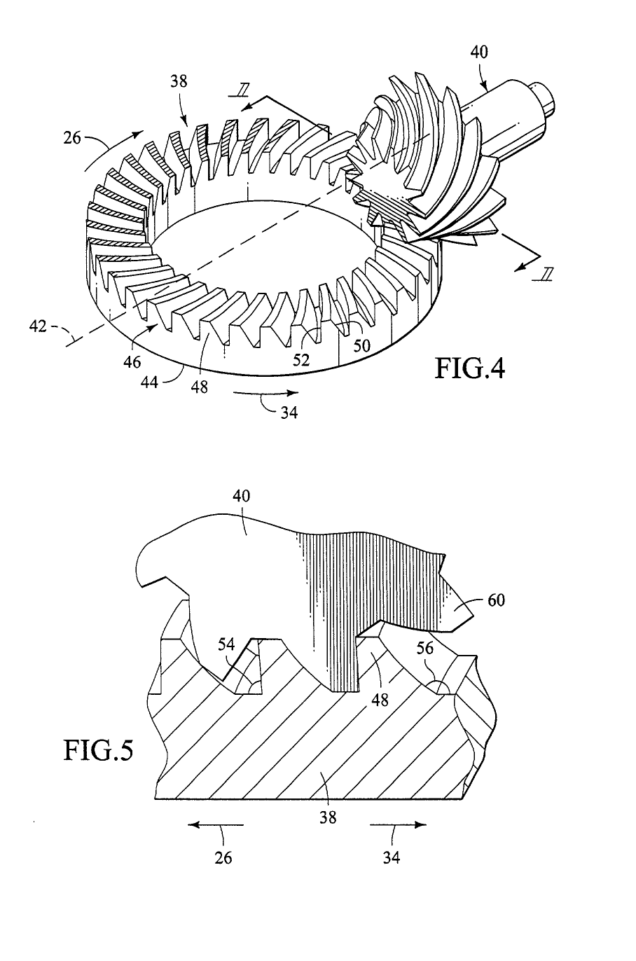

An advantage to this invention is that it allows a hypoid gear set as shown in FIG. 4 to be mounted in the same position as the prior art hypoid gear set from FIG. 1. The new hypoid gear set can be run in a coast direction 34 without losing either its efficiency or its fatigue strength.

FIG. 4 shows the preferred embodiment of the invention. The new hypoid gear set has a ring-shaped gear 38 and a pinion gear 40. The pinion gear 40 intermeshes with the ring-shaped gear 38 at a point below the axis 42 of the ring-shaped gear 38. The ring-shaped gear 38 has a base having a first side 44 and a second side 46. The first side 44 is flat and the second side 46 preferably defines a plurality of teeth 48 which each have a drive side 50 and a coast side 52. An arrow 26 shows the drive side direction. The drive side 50 receives driving force from the pinion gear 40.

FIG. 3 shows an enlarged view of a ring gear tooth 48 of the invention. Each tooth 48 has a first pressure angle 54 and a second pressure angle 56. The first pressure angle 54 is on the coast side 52 and the second pressure angle 56 is on the drive side 50 which is on the concave face of the gear tooth 48. In the preferred embodiment of the invention, the first pressure angle 54 is shallower than the second pressure angle 56 in reference to an axially extending line 58. This puts the steeper second pressure angle 56 on the coast side 52 of the gear tooth 48.

In order to determine the proper measurements for this embodiment of the invention, the designer preferably first calculates the appropriate pressure angles for the machine. From these calculations, the designer then determines the inverse of each pressure angle. Preferably, subtracting the original pressure angle from the sum of the two pressure angles accomplishes this. Once the inverse of both the first and second pressure angles is determined, the designer preferably cuts the inverse of the original drive side pressure angle into the coast side, and cuts the inverse of the original coast side pressure angle into the drive side. This results in a hypoid gear set where the steeper pressure angle is actually on the coast side of the gear teeth. The hypoid gear set can be mounted in its usual position in the machine and can be run in a reverse direction without losing any efficiency or fatigue strength.

FIG. 5 shows an enlarged view of the interaction between the pinion teeth 60 and the ring-shaped gear teeth 48 as viewed along line 1-1 in FIG. 4. A line 26 shows the drive direction and a line 34 shows the coast direction. The first pressure angle 54 and the second pressure angle 56 are displayed on the ring-shaped gear teeth 48 and the pinion teeth 60 are cut appropriately to match them.

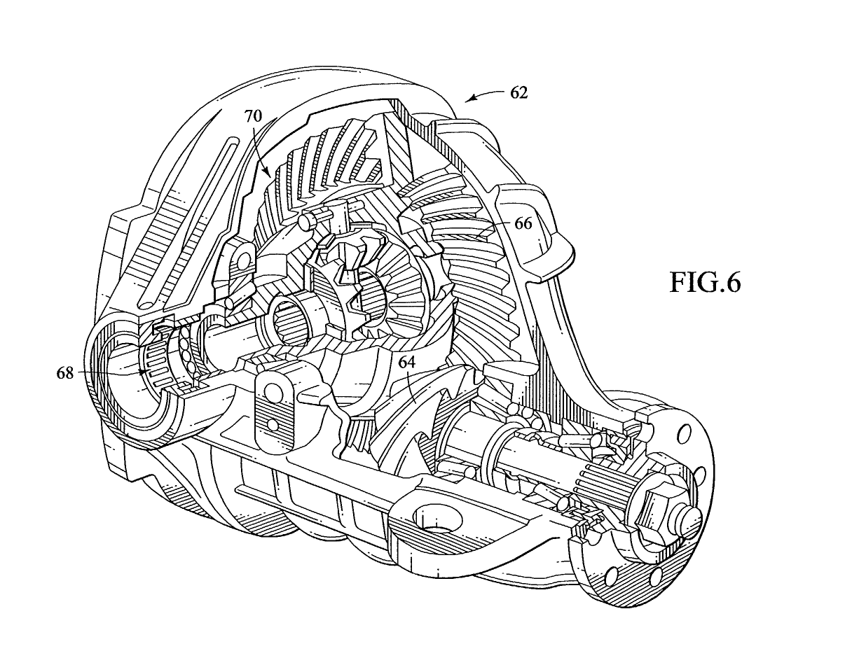

FIG. 6 shows a hypoid gear set in place in a rear axle carrier package 62. This Figure illustrates the space constraints present in many of today's vehicles. This orientation shows the pinion gear 64 intersecting the ring-shaped gear 66 at a point below the axle 68. This is the preferable orientation as it allows for a lower profile of the vehicle. Because of the shape of the package, it is impossible to either mount the pinion gear 64 above the axle 68 or on the opposite side 70 of the axle 68. So, when these packages are mounted as part of a power-take-off or four-wheel drive mechanism, some of these packages will face the opposite direction. In order to have all the axles 68 spinning in the same direction, some of the packages must be run in reverse. These reversed packages become drive-on-coast. In other words, the drive direction is actually the original coast side. Utilizing the preferred embodiment of the invention, an identical configuration of hypoid gear set can be mounted in this reverse position and run in reverse without any loss of efficiency or fatigue strength. Because this hypoid gear set is relatively simple to construct, there is little redesign cost, and it is not necessary to perform many extra complex calculations.

It should be noted that there could be a wide range of changes performed on the new hypoid gear set and it could be designed using any gear set as a basic template. Thus, it is intended that the foregoing detailed description be regarded as illustrative rather than limiting and that it be understood that it is the following claims, including all equivalents, which are intended to define the scope of the invention.

What is claimed is:

1. A hypoid gear set comprising:
a ring-shaped hypoid gear positioned about an axis and having a plurality of curved gear teeth arranged about said axis, each of said teeth having a first side and a second side opposite therefrom, said second side having a forward face defining a drive side extending at a shallow pressure angle relative to an axially extending line, and said first side having a rear face defining a coast side extending at a steep pressure angle relative to said forward face; and
a pinion gear intermeshing with a portion of said plurality of teeth on said ring shaped gear to drive said rear faces of said teeth such that said ring shaped gear rotates in the direction of said forward faces on each of said teeth.

2. The hypoid gear set of claim 1, wherein said hypoid gear set interfaces with a reversed portion of a transmission.

3. The hypoid gear set of claim 2, wherein said hypoid gear set is generally run in a reversed direction.

4. A method of cutting a new hypoid ring gear based on a standard hypoid ring gear, said standard hypoid ring gear having a plurality of teeth each having a first side and a second side, said first side defining the coast side and having a first pressure angle, said second side defining the drive side and having a second pressure angle shallower than the angle of said first pressure angle, said method comprising the steps of:
determining the first pressure angle of said standard hypoid ring gear;
determining the second pressure angle of said standard hypoid ring gear;
determining the inverse angle of said first pressure angle;
determining the inverse angle of the second pressure angle;
cutting said inverse first pressure angle into the drive side of said new hypoid ring gear; and
cutting said inverse second pressure angle into the coast side of said new hypoid ring gear.

5. The method of claim 4, wherein the step of determining the first and second pressure angles is performed by a computer program and the step of determining the inverse angles of said first and second pressure angles is performed manually.

6. A ring-shaped hypoid gear for interfacing with a driving pinion gear, said ring-shaped gear comprising:
a base defining a plurality of curved teeth, the convex side of said teeth facing in the direction of rotation of said gear;
each of said teeth comprising a drive side on said concave face of said tooth to receive a driving force from said pinion gear; and
a coast side defined by a convex face opposite said concave face.
